(19) United States
(12) Patent Application Publication
(10) Pub. No.: US 2016/0349863 A1
(43) Pub. Date: Dec. 1, 2016

(54) MULTI-FUNCTIONAL STYLUS FOR MOBILE TERMINAL

(71) Applicant: HON HAI PRECISION INDUSTRY CO., LTD., New Taipei (TW)

(72) Inventor: HUNG-LING WEI, New Taipei (TW)

(21) Appl. No.: 14/835,749

(22) Filed: Aug. 26, 2015

(30) Foreign Application Priority Data
May 27, 2015 (TW) 104116940

(51) Int. Cl. G06F 3/0354; G06F 3/038; G06F 3/041

(52) U.S. Cl. CPC G06F 3/03545; G06F 3/0416; G06F 3/0383

(57) ABSTRACT

A stylus used to contact a touch screen of a mobile terminal includes a main body, a wireless communication module, and an indicator. The wireless communication module is positioned inside the main body. The indicator is positioned on the main body. When a communication connection is established between the wireless communication module and the mobile terminal, the indicator indicates the mobile terminal has received one or more communication events.

### FIELD

The subject matter herein generally relates to styluses, and particularly to a multi-functional stylus and a mobile terminal using the stylus.

### BACKGROUND

Many electronic devices include styluses for inputting information and selecting menu options. The styluses may only be used to input data via touch the electronic device.

### BRIEF DESCRIPTION OF THE DRAWINGS

Implementations of the present technology will now be described, by way of example only, with reference to the attached figures.

FIG. 1 is an isometric view of a stylus and a mobile terminal having the stylus, according to an exemplary embodiment.

FIG. 2 is an isometric view of the stylus of FIG. 1.

FIG. 3 is a diagrammatic view of the stylus of FIG. 1 being used to the mobile terminal

FIG. 4 is a flowchart of one embodiment of a controlling method using the stylus of FIG. 1 to operate the mobile terminal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

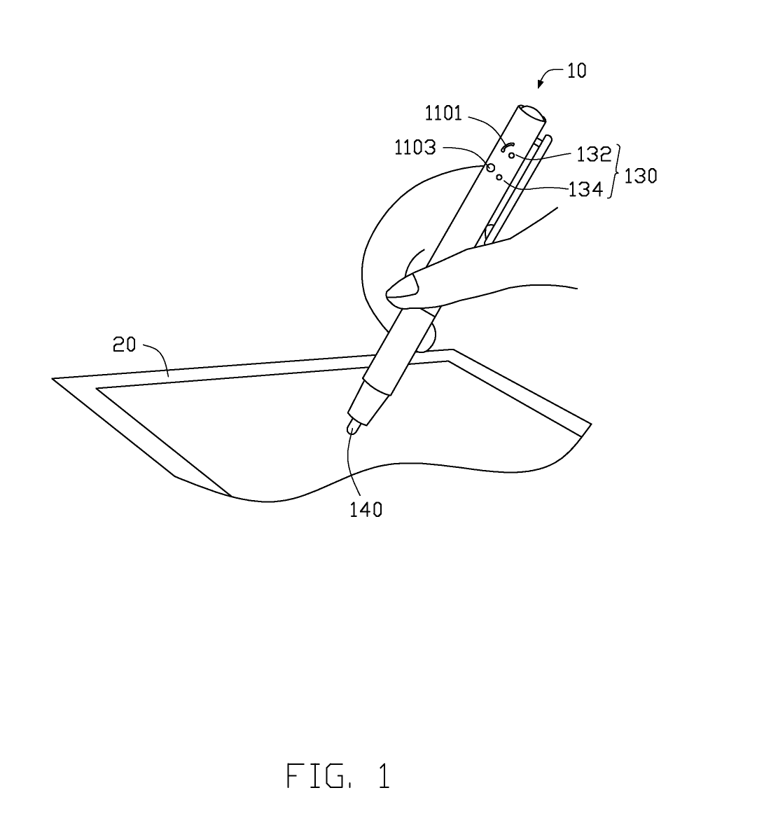

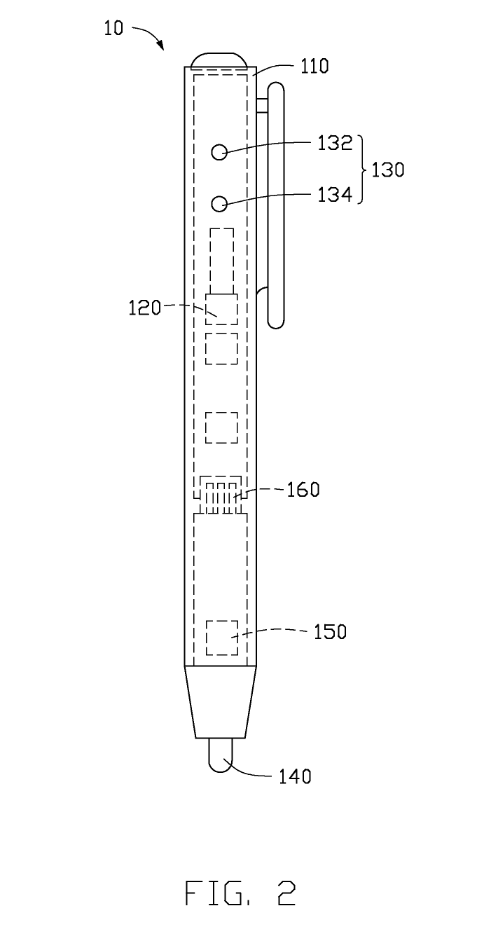

FIG. 1 illustrates an isometric view of a stylus 10 and a mobile terminal 20 having the stylus 10, according to an exemplary embodiment. FIG. 2 illustrates that the stylus 10 includes a main body 110, a wireless communication module 120 located inside the main body 110, a indicator 130 located outside the main body 10. The indicator 130 protrudes from the main body 110. The stylus 10 further includes a tip portion 140 positioned at an end of the main body 110, a battery 150 positioned inside the main body 130, and a charging interface 160 for charging the battery 150.

The wireless communication module 120 is configured for communicating with a mobile terminal 20. The stylus 10 can be detachably assembled to the mobile terminal 20. The indicator 130 is configured for indicating communication events of the mobile terminal 20 according to communication between the mobile terminal 20 and the stylus 10, when the mobile terminal 20 successfully matches with the stylus 10 (i.e. a communicating connection is established between the mobile terminal 20 and the stylus 10). The communication events includes incoming call events and message events. The incoming call event is defined as a new call is received by the mobile terminal 20. The message event is defined as a new message is received by the mobile terminal 20. The tip portion 140 is configured for contacting a touch screen 210. The touch screen 210 senses touch actions from the tip portion 140 for controlling the mobile terminal 20 to execute a corresponding operation (or command). The battery 150 is configured for providing power for the wireless communicating device 120. The charging interface 160 can be a mini USB interface. In other exemplary embodiment, the charging interface 160 can be omitted, and the battery 150 can be wireless charged.

In this exemplary embodiment, the mobile terminal 20 can be, but not limited to, a portable electronic device having the touch screen 210 such as a smart phone, a tablet computer, and so on. The wireless communication module 120 can be a Bluetooth module, accordingly, the mobile terminal 20 also has a Bluetooth to communicate with the stylus. In other exemplary embodiment, the wireless communication module 120 can be a Near Field Communication (NFC) module.

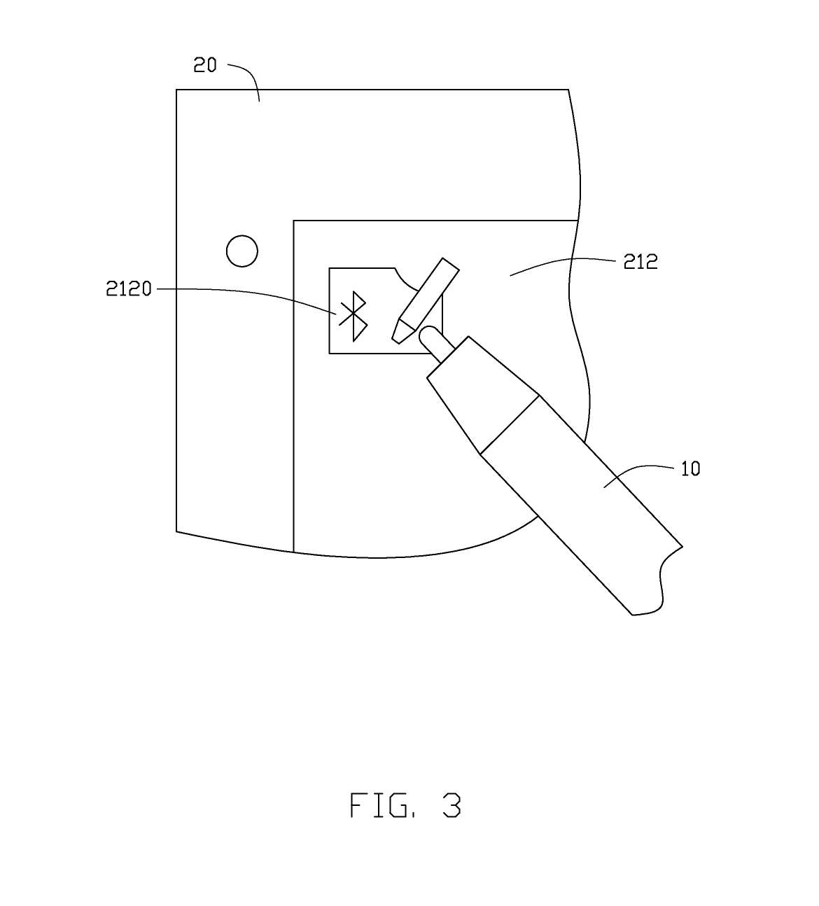

FIG. 3 illustrates a diagrammatic view of the stylus 10 of FIG. 1 being used to the mobile terminal 20. The touch screen 210 displays a user interface 212. In this exemplary embodiment, the user interface 212 is a folder interface, and a Bluetooth icon 2120 is displayed on the folder interface. The Bluetooth icon 2120 represents that the folder is protected. The folder can be opened or accessible only when the stylus 20 successfully matches with the mobile terminal 20. When the stylus 10 contacts the user interface 212, the mobile terminal 20 firstly determines whether the stylus 10 is usable for the mobile terminal 20. The mobile terminal sends a first signal to the stylus 10. The wireless communication module receives the first signal. If the first signal can be identified by the stylus 10 (i.e. the stylus 10 is usable for the mobile terminal 20), the wireless communication module 120 sends a second signal to the mobile terminal 20, so that the mobile terminal 20 successfully matches with the stylus 10. The mobile terminal 20 executes a corresponding command of the stylus 10 such as opening the folder or editing contents of the folder.

If the first signal cannot be identified by the stylus 10 and the mobile terminal 20 unsuccessfully matches with the stylus 10, the mobile terminal 20 does not execute the corresponding command so that the user interface 212 is protected. In an exemplary embodiment, the mobile terminal 20 and the stylus 10 match with each other by a preset password. The preset password is contained in the first signal. In other exemplary embodiment, the mobile terminal 20 matches with the stylus 10 when the mobile terminal 20 is in a locked state.

In this exemplary embodiment, the stylus 10 matches with the mobile terminal 20 by the wireless communication module 120. The mobile terminal 20 executes the corresponding operation of the stylus 10 only when the stylus 10 successfully matches with the mobile terminal 20 so that security of files and operations of the mobile terminal 20 can be increased.

The indicator 130 includes a first indicator light 132 and a second indicator light 134. The first indicator light 132 is configured for indicating incoming call events of the mobile terminal 20. The second indicator light 134 is configured for indicating message events of the mobile terminal 20. The main body 110 includes a first symbol 1101 corresponding to the first indicating light 132 and a second symbol 1103 corresponding to the second indicating light 134. The first symbol 1101 is an earphone receiver logo. The second symbol 1103 is an envelope logo. The first symbol 1101 is configured for representing that the new incoming call is received when the first indicating light 132 is turned on. The second symbol 1103 is configured for representing that the new message is received when the second indicating light 134 is turned on.

When the mobile terminal 20 receives the new incoming call, the first indicating light 132 is turned on. In this exemplary embodiment, the first indicating light 132 blinks to indicate an user of the mobile terminal 20 that the new incoming call is received. When the mobile terminal 20 receives the new message, the second indicating light 134 is turned on. The second indicating light 134 blinks to indicate the user of the mobile terminal 20 that the new message is received. In this exemplary embodiment, the first and second indicating lights 132, 134 have different colors, for example, the first indicating light 132 is green, and second indicating light 134 is yellow. The first and second indicating lights 132, 134 can both be light emitting diodes.

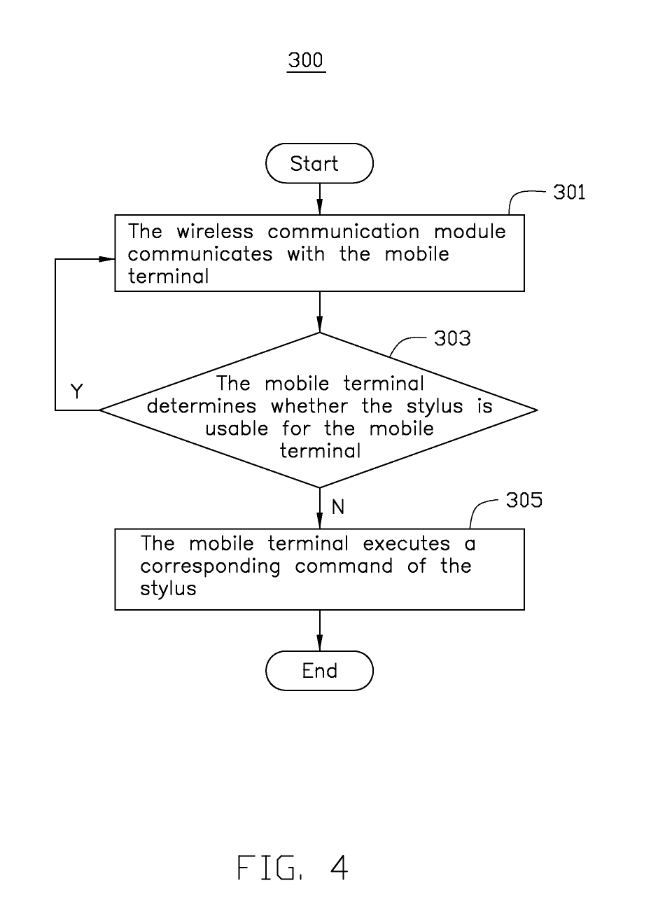

FIG. 4 presents a flowchart in accordance with an example embodiment. The example method 300 is provided by way of example, as there are a variety of ways to carry out the method. Each block shown in FIG. 4 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the wireless communication module 120 communicates with the mobile terminal 20.

At block 303, the mobile terminal 20 determines whether the stylus 10 is usable for the mobile terminal 20. The touch screen 210 displays a user interface 212. In this exemplary embodiment, the user interface 212 is a folder interface, and a Bluetooth icon 2120 is displayed on the folder interface. The Bluetooth icon 2120 represents that the folder is protected. The folder can be opened only when the stylus 20 matches with the mobile terminal 20.

When the stylus 10 contacts the user interface 212, the mobile terminal 20 firstly determines whether the stylus 10 can be usable for the mobile terminal 20. The mobile terminal 20 sends a first signal to the stylus 10. The wireless communication module 120 receives the first signal. If the first signal can be identified by the stylus 10 (i.e. the stylus 10 is suitable for the mobile terminal 20), the wireless communication module 120 sends back a second signal to the mobile terminal 20, so that the mobile terminal 20 successfully matches with the stylus 10, then the process goes to block 305.

If the first signal cannot be identified by the stylus 10 and the mobile terminal 20 unsuccessfully matches with the stylus 10, the mobile terminal 20 does not execute the corresponding command so that the user interface 212 is protected, the process goes back to block 301.

At block 305, the mobile terminal 20 executes a corresponding command of the stylus 10 such as opening the folder or editing content of the folder. In addition, when the mobile terminal 20 receives the new incoming call, the first indicating light 132 is turned on. In this exemplary embodiment, the first indicating light 132 twinkles to indicate an user of the mobile terminal 20 that the new incoming call is received. When the mobile terminal 20 receives the new message, the second indicating light 134 is turned on. In this exemplary embodiment, the second indicating light 134 blinks to indicate the user of the mobile terminal 20 that the new message is received.

The stylus 10 matches with the mobile terminal 20 by the wireless communication module 120. Only when the stylus 10 successfully matches with the mobile terminal 20, the mobile terminal 20 receives the command from the stylus 10. In addition, the stylus 10 indicates communication events of the mobile terminal 20 by the indictor 130. Therefore, the stylus 10 is multi-functional. Furthermore, the mobile terminal 20 executes the corresponding operation of the stylus 10 only when the stylus 10 successfully matches with the mobile terminal 20 so that, security of files and operations of the mobile terminal 20 is increased.

It is to be understood, however, that event through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A stylus used to contact a touch screen of a mobile terminal, the stylus comprising:
a main body;
a wireless communication module positioned inside the main body; and
an indicator positioned on the main body, wherein when a communication connection is established between the wireless communication module and the mobile terminal, the indicator indicates the mobile terminal has received one or more communication events.

2. The stylus of claim 1, wherein the communication events comprises incoming call events and message events.

3. The stylus of claim 2, wherein the indicator comprises a first indicating light configured for indicating the incoming call events and a second indicating light configured for indicating the message events.

4. The stylus of claim 1, wherein when the stylus contacts the touch screen, the stylus matches with the mobile terminal.

5. The stylus of claim 4, wherein when the stylus successfully matches with the mobile terminal, the mobile terminal execute a corresponding command input by the stylus; when the stylus unsuccessfully matches with mobile terminal, the mobile terminal does not execute the corresponding command.

6. The stylus of claim 4, wherein when the stylus contacts the touch screen, the mobile terminal sends a first signal to the stylus, the wireless communication module receives the first signal, if the first signal can be identified by the stylus, the wireless communication module sends a second signal to the mobile terminal so that the stylus successfully matches with the mobile terminal

7. The mobile terminal of claim 6, wherein if the first signal cannot be identified by the stylus and the mobile terminal unsuccessfully matches with the stylus.

8. The mobile terminal of claim 1, wherein the indicator protrudes from the main body, the stylus further comprises a tip portion positioned at an end of the main body, a battery positioned inside the main body, and a charging interface for charging the battery.

9. A mobile terminal, comprising:
a touch screen; and
a stylus for contacting the touch screen, the stylus comprising:
a main body;
a wireless communication module positioned inside the main body; and
an indicator positioned on the main body, wherein when a communication connection is established between the wireless communication module and the mobile terminal, the indicator indicates the mobile terminal has received one or more communication events.

10. The mobile terminal of claim 9, wherein the communication events comprises incoming call events and message events.

11. The mobile terminal of claim 10, wherein the indicator comprises a first indicating light configured for indicating the incoming call events and a second indicating light configured for indicating the message events.

12. The mobile terminal of claim 9, wherein when the stylus contacts the touch screen, the touch screen provides a user interface being protected, when the stylus successfully matches with the mobile phone, the user interface is accessible.

13. The mobile terminal of claim 12, wherein when the stylus contacts the touch screen, the mobile terminal sends a first signal to the stylus, the wireless communication module receives the first signal, if the first signal can be identified by the stylus, the wireless communication module sends a second signal to the mobile terminal so that the stylus successfully matches with the mobile terminal

14. The mobile terminal of claim 13, wherein if the first signal cannot be identified by the stylus and the mobile terminal unsuccessfully matches with the stylus.

15. The mobile terminal of claim 12, wherein user interface is a folder interface.

16. The mobile terminal of claim 12, wherein the stylus matches with the mobile terminal by a preset password contained in the first signal.

17. The mobile terminal of claim 9, wherein the indicator protrudes from the main body, the stylus further comprises a tip portion positioned at an end of the main body, a battery positioned inside the main body, and a charging interface for charging the battery.
